(19) United States
(12) Patent Application Publication
(10) Pub. No.: US 2024/0255701 A1
(43) Pub. Date: Aug. 1, 2024

(54) OPTICAL SENSORS

(71) Applicant: DIFTEK LASERS, INC., Waterloo (CA)

(72) Inventor: Douglas R. DYKAAR, Waterloo (CA)

(21) Appl. No.: 18/417,108

(22) Filed: Jan. 19, 2024

Related U.S. Application Data
(60) Provisional application No. 63/442,150, filed on Jan. 31, 2023.

(51) Int. Cl. G02B 6/26; G02B 6/02

(52) U.S. Cl. CPC G02B 6/262; G02B 6/02333; G02B 6/02361

(57) ABSTRACT

There is provided an optical sensor for sensing a target, having an input optical conduit, an output optical conduit, and an optical field generator optically coupled to the input and the output optical conduits. The input optical conduit may receive an input light and guide the input light towards the optical field generator. The optical field generator may receive the input light from the input optical conduit, and may generate based on the input light an optical field extending at least partially outside of the optical field generator to interact with the target to generate an altered light. The target may be positioned outside the optical field generator. The optical field generator may also guide the altered light to the output optical conduit. The output optical conduit may receive the altered light from the optical field generator.

### CROSS-REFERENCE TO RELATED APPLICATION

This application claims priority from U.S. Provisional Patent Application No. 63/442,150, filed on Jan. 31, 2023, which is incorporated herein by reference in its entirety.

### FIELD

The present specification relates to sensors, and in particular to optical sensors.

### BACKGROUND

To obtain more information about an entity or environment, one or more parameters about that entity or environment may be obtained. Obtaining such a parameter may include measuring or sensing the parameter. One or more sensors may be used to sense such a parameter.

### SUMMARY

According to an aspect of the present specification there is provided an optical sensor for sensing a target, the optical sensor comprising: an input optical conduit, an output optical conduit, and an optical field generator optically coupled to the input optical conduit and the output optical conduit; the input optical conduit to receive an input light and to guide the input light towards the optical field generator; the optical field generator to: receive the input light from the input optical conduit; generate based on the input light an optical field extending at least partially outside of the optical field generator to interact with the target to generate an altered light, the target positioned outside the optical field generator; and guide the altered light to the output optical conduit; and the output optical conduit to receive the altered light from the optical field generator.

The optical field generator may comprise a capillary having an outer surface and a capillary tube, the capillary having a first end optically coupled to the input optical conduit and a second end opposite the first end, the second end optically coupled to the output optical conduit, the capillary to generate the optical field extending outside of the outer surface of the capillary.

The input optical conduit may comprise an optical fiber having a core, the core having a core diameter; the capillary tube having a first capillary tube diameter at the first end and a second capillary tube diameter away from the first end and away from the second end; and the first capillary tube diameter is smaller than the core diameter. The first capillary tube diameter may be less than about 5 microns.

The first capillary tube diameter may be smaller than the second capillary tube diameter.

The capillary tube may have a third capillary tube diameter at the second end, the third capillary tube diameter being smaller than the second capillary tube diameter.

The output optical conduit may comprise a corresponding optical fiber having a corresponding core, the corresponding core having a corresponding core diameter; and the third capillary tube diameter may be smaller than the corresponding core diameter.

The capillary may be free of a covering on the outer surface of the capillary.

The optical field generator may comprise a coreless optical fiber having a first end optically coupled to the input optical conduit and a second end opposite the first end, the second end optically coupled to the output optical conduit, the coreless optical fiber being free of a covering on an outer surface of the coreless optical fiber.

The optical field generator may comprise a light guide having a first end optically coupled to the input optical conduit and a second end opposite the first end, the second end optically coupled to the output optical conduit, the light guide having an axis of light propagation extending through the light guide from the first end to the second end, the light guide having an index of refraction that changes along the light guide along a direction lateral to the axis of light propagation.

The index of refraction may increase when moving along the direction from a core of the light guide towards an outer surface of the light guide.

The light guide may comprise a photonic crystal fiber.

The optical field generator may comprise a light guide having a first end and a second end opposite the first end, the optical field generator optically coupled to the input optical conduit proximate the first end and optically coupled to the output optical conduit proximate the second end, the light guide having an axis of light propagation extending through the light guide from the first end to the second end, the light guide having a polygonal cross-section normal to the axis of light propagation.

The polygonal cross-section may be a tetragonal cross-section.

The light guide may be shaped such that the axis of light propagation is non-straight.

One or both of the input optical conduit and the output optical conduit may comprise a prism optically coupled to the light guide.

The optical field may comprise an evanescent field.

The input optical conduit may comprise an optical fiber.

The output optical conduit may comprise an optical fiber.

The optical sensor may further comprise one or more of: a light source to generate the input light, the light source optically coupled to the input optical conduit; and a detector to detect the altered light, the detector optically coupled to the output optical conduit.

The output optical conduit may be to guide the altered light towards a detector.

The output optical conduit may be a component of a detector.

The capillary may have an index of refraction that remains substantially unchanged when moving along the capillary form the first end to the second end.

The optical sensor may further comprise: an emitter disposed outside the optical field generator, the emitter to emit an incident optical beam transverse to the optical field generator, the incident optical beam to become incident upon the optical field generator to generate an emitted optical beam emanating from the optical field generator; a detector to detect the emitted optical beam; and whereby an insertion loss is to be generated based on the incident optical beam and the emitted optical beam, the insertion loss being associated with a condition of the optical field generator.

The optical sensor may further comprise a coating on at least a portion of a surface of the optical field generator exposed to the target, the coating having an optical property, the coating to interact with the target to form an altered coating having an altered optical property, wherein: the optical field is to interact with the altered coating to generate the altered light.

According to another aspect of the present specification there is provided an optical sensor for sensing a target, the optical sensor comprising: an optical conduit terminating in a first end; an optical field generator having a second end and a third end opposite the second end; an optical resonance chamber formed between the first end and the second end, the optical resonance chamber being at least partially isolated from an environment external to the optical sensor to keep out at least the target; the optical conduit to receive an input light and to guide the input light towards the optical resonance chamber; the optical field generator to: receive the input light from the optical resonance chamber; generate based on the input light an optical field extending at least partially outside of the optical field generator to interact with the target to generate an altered light, the target positioned outside the optical field generator; and guide the altered light to the optical resonance chamber; and wherein: the altered light is to interfere with the input light in the optical resonance chamber to generate an output light; and the optical conduit is to receive the output light from the optical resonance chamber.

The optical resonance chamber may comprise a Fabry-Perot chamber.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 shows a schematic representation of an example optical sensor, in accordance with a non-limiting implementation of the present specification.

FIG. 2 shows a schematic representation of another example optical sensor, in accordance with a non-limiting implementation of the present specification.

FIG. 3 shows a magnified version of the optical sensor of FIG. 2.

FIG. 4 shows a schematic representation of yet another example optical sensor, in accordance with a non-limiting implementation of the present specification.

FIG. 5 shows a schematic representation of yet another example optical sensor, in accordance with a non-limiting implementation of the present specification.

FIG. 6 shows an example index of refraction profile, in accordance with a non-limiting implementation of the present specification.

FIG. 7 shows a schematic representation of yet another example optical sensor, in accordance with a non-limiting implementation of the present specification.

FIG. 8 shows a schematic representation of yet another example optical sensor, in accordance with a non-limiting implementation of the present specification.

FIG. 9 shows a schematic representation of yet another example optical sensor, in accordance with a non-limiting implementation of the present specification.

FIG. 10 shows a schematic representation of yet another example optical sensor, in accordance with a non-limiting implementation of the present specification.

FIG. 11 shows a schematic representation of yet another example optical sensor, in accordance with a non-limiting implementation of the present specification.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, and the like.

Moreover, in the following description, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

Different types of sensors may be used for sensing parameters associated with an entity or an environment. Such types of sensors may include magnetic sensors, mechanical sensors, electrical sensors, optical sensors, and the like. In the case of optical sensors, interaction of light with a target allows the sensors to obtain information about that target. In some examples, enhancing or increasing the interaction between the light and the target may enhance the performance of the optical sensor.

Optical fibers may be used to guide or conduct light, by containing most of the light within the fiber. In the case of optical fiber-based optical sensors, the light traveling inside the fiber is brought into contact with a target to allow for interaction between the light and the target and thereby optical sensing of the target. In some examples, light may be made to leave the fiber and propagate in free space to interact with the target. Such free-space propagation based optical sensors may face challenges related to optical alignment, safety, cost, and the like.

Moreover, in some examples, the core of an optical fiber may be exposed or altered (e.g. roughened, etc.) to allow some of the light travelling in the core to leak out to interact with the target. Such exposing or alterations of the optical fiber may render the fiber mechanically fragile or otherwise compromised, and may undermine the durability or performance of the optical sensor. In addition, in some examples, gratings or other optical features in the core of the optical fiber may be used to make the light in the fiber available for interaction with the target. Such gratings or optical features may be complex to manufacture and expensive. Some of the above approaches for making the light in a fiber available for interaction with a target may also provide only relatively short interaction lengths between the light and the target, thereby limiting the performance of the optical fiber.

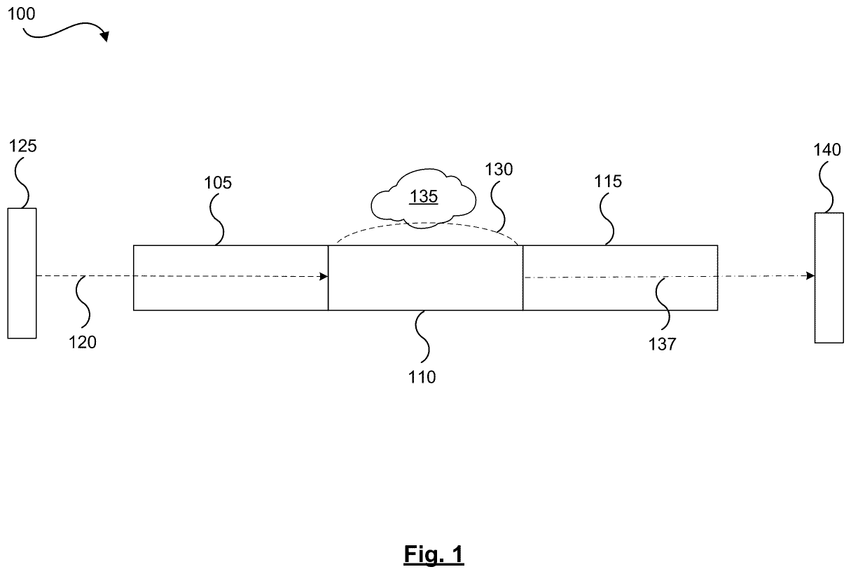

FIG. 1 shows a schematic representation of an example optical sensor 100 that allows light to interact with a target, thereby allowing optical sensor 100 to sense one or more parameters associated with the target. Optical sensor 100 may also be referred to as sensor 100, in short. Sensor 100 comprises an input optical conduit 105, an optical field generator 110, and an output optical conduit 115. Optical field generator 110 may also be referred to as field generator 110, in short. Field generator 110 is optically coupled to input optical conduit 105 and output optical conduit 115.

Two components being optically coupled may include one component being able to send light to the other component. For example, the first component may be optically aligned, with or without intervening optical components, to send light to the other component. Some or all of the optical path between the first and second components may or may not traverse free space. Moreover, in some examples, the first component may be optically connected to the second component using a light conductor or conduit such as an optical fiber, light guide, and the like.

Input and output optical conduits 105 and 115 may comprise a component capable of directing or guiding light, such as an optical fiber, a light guide, a prism, and the like. Input optical conduit 105 may receive an input light 120 and guide that light toward field generator 110. In some examples, input light 120 may be generated by a light source 125 optically coupled to input optical conduit 105. In some examples, light source 125 need not form a part of optical sensor 100. Moreover, in some examples, light source 125 may comprise a light emitting diode (LED) light source, a laser light source, and the like.

Field generator 110 may then receive input light 120 from input optical conduit 105, and generate based on input light 120 an optical field 130 extending at least partially outside of field generator 110. Optical field 130 may also be referred to as field 130, in short. Field 130 may interact with a target 135 positioned outside field generator 110. This interaction may generate an altered light 137. Field generator 110 may guide altered light 137 to output optical conduit 115. In some examples, optical field 130 may comprise an evanescent field. The evanescent field results from the total internal reflection at the dielectric interface of a source field. At the interface the boundary condition is that the electric field is continuous across the boundary, resulting in an exponentially decaying electric field in the surrounding dielectric. In the case where the dielectric is uniform, homogeneous and lossless, the Poynting vector is zero. If however, the evanescent field is absorbed in any way, the source field will also be affected as energy is conserved.

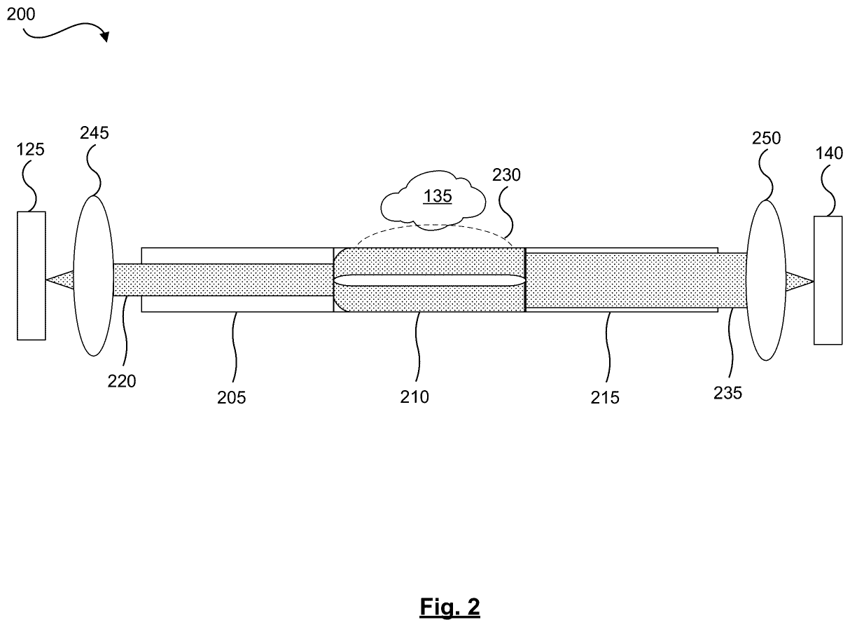

In some examples, target 135 may comprise a molecule, particle, droplet, or another entity capable of interacting with field 130. Moreover, in FIG. 1 field 130 is shown on only one side of field generator 110. Similarly, FIGS. 2, 4, 5, 7, 8, 10, and 11 show an optical field on one of the corresponding field generators. Such a depiction is for ease of illustration only. In examples where the field generator has a rotational symmetry about the axis of propagation of the light from the input optical conduit, via the field generator, to the output optical conduit, the optical field generator may also have the corresponding rotational symmetry about the axis of propagation.

For example, if the field generator has a 360° rotational symmetry (e.g. in cases where the field generator has a circular or annular cross-section), then the optical field generated may also have a corresponding 360º rotational symmetry. In other words, the optical field would be present 360º around the field generator. Similarly, if the field generator has a 60° or 90° rotational symmetry (e.g. in cases where the field generator has a hexagonal or square cross-section respectively), the optical field generated may also have a corresponding 60° or 90° rotational symmetry.

Once interaction between field 130 and target 135 generates altered light 137, field generator 110 guides altered light 137 to output optical conduit 115, which output optical conduit 115 then receives altered light 137. Output optical conduit 115 may then guide altered light 137 towards a detector 140 to detect the altered light. Detector 140 may be optically coupled to output optical conduit 115. It is contemplated that in some examples, the detector may be a component separate from the optical sensor, and that the optical sensor need not comprise a detector.

As shown in FIG. 1, output optical conduit 115 may guide altered light 137 towards detector 140. Moreover, in some examples, the output optical conduit may be a component of a detector. By generating optical field 130 based on input light 120, sensor 100 makes the light available for interaction with target 135 outside sensor 100, without undermining the mechanical integrity of field generator 110 or resorting to expensive gratings or other optical features in field generator 110. Moreover, sensor 100 may achieved a desired optical interaction length with the target by, for example, tailoring the length of field generator 110.

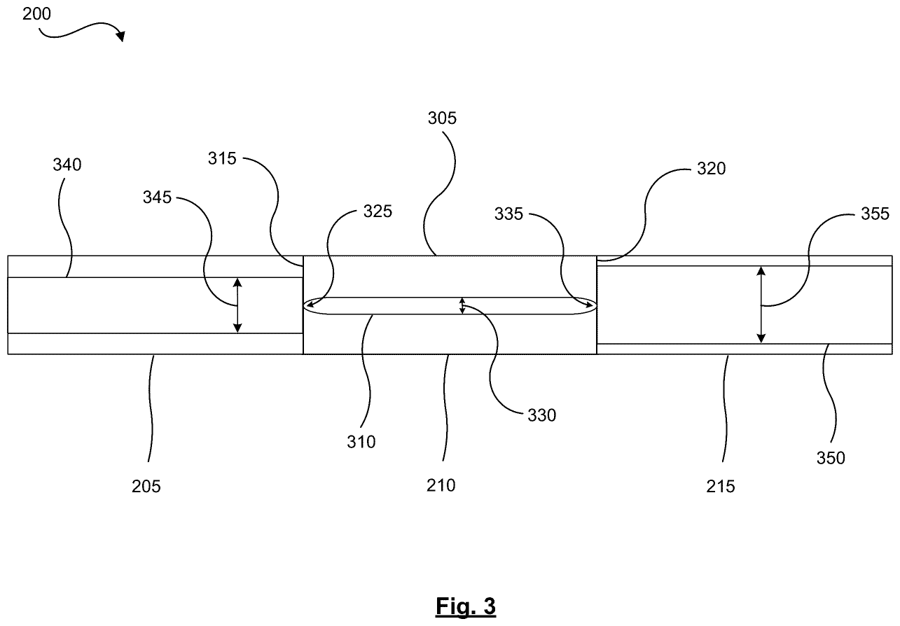

Turning now to FIG. 2, a schematic representation is shown of another example optical sensor 200. Sensor 200 is similar to sensor 100 in that sensor 200 comprises an input optical conduit 205, an optical field generator 210, and an output optical conduit 215. Conduits 205 and 215 may be similar to conduits 105 and 115 respectively. In sensor 200 field generator 210 comprises a capillary, which capillary is described in greater detail in relation to FIG. 3. Field generator 210 receives an input light 220 from conduit 205 and generates an optical field 230, which optical field 230 may be similar to optical field 130. Optical field 230 may then interact with target 135 to generate an altered light 235, which altered light 235 is then guided by field generator 210 to conduit 215.

It is contemplated that in some examples, detector 140 may be adjacent or abutting the end of conduit 215 that is opposite field generator 210. It is also contemplated that in some examples, sensor 200 need not comprise conduit 215, and that detector 140 may be adjacent or abutting the end of field generator 210 (i.e. end 320 shown in FIG. 3) opposite conduit 205.

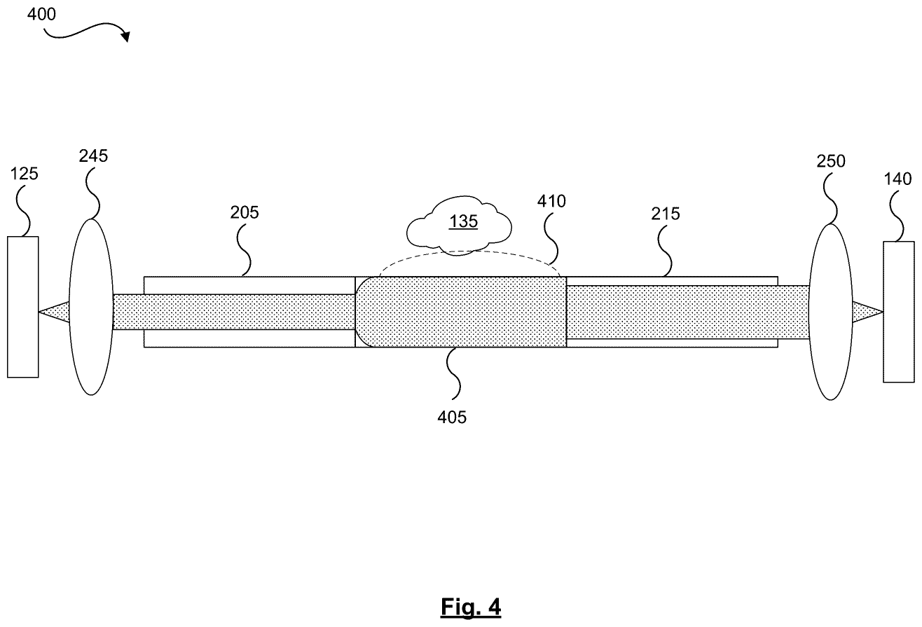

Light source 125 may be used to generate input light 220 and detector 140 may be used to receive altered light 235. Optical elements such as lenses 245 and 250 may be used to condition input light 220 and altered light 235 respectively. For the optical sensor shown in FIG. 2, and also the optical sensors shown in FIGS. 4, 5, 10, and 11, one or more of the light source and the detector need not form a part of the optical sensor. Moreover, in some examples, optical elements in addition to, or other than, lenses may be used to condition input and altered lights. It is also contemplated that in some examples, no optical elements may be used to condition the input or altered lights.

FIG. 3 shows a magnified depiction of optical sensor 300. As described earlier, field generator 210 comprises a capillary having an outer surface 305 and a capillary tube 310. The capillary has a first end 315 optically coupled to input optical conduit 205, and a second end 320 opposite first end 315. Second end 320 is optically coupled to output optical conduit 215. The capillary field generator may generate optical field 230 extending outside of outer surface 305 of the capillary, as shown in FIG. 2.

The capillary field generator 210 may have a first capillary tube diameter 325 at first end 315 and a second capillary tube diameter 330 away from first end 315 and away from second end 320. While FIG. 3 shows capillary tube 310 as being closed or substantially closed at first and second ends 315 and 320 (i.e. capillary tube diameters 325 and 335 as approaching or being about zero), it is contemplated that in some examples the capillary tube may be open at one or more of ends 315 and 320 (i.e. one or more of capillary tube diameters 325 and 335 may be greater than zero).

The portions of the capillary with reduced diameter may be formed using suitable techniques. In some examples, an optical splice process may be used to attach and optically couple the input conduit to the field generator, and the field generator to the output conduit. This optical splice process may cause the glass of the capillary to become softened or molten in a volume including both the ends of the optical elements as well as material adjacent to the end, i.e. in the region of the splice. Surface tension causes the molten corpus or volume to at least partially collapse the capillary tube in the region of the splice. This type of collapse may cause the capillary tube diameter to be reduced, in some cases to zero.

In addition, while FIGS. 2 and 3 show the capillary tube as having reduced diameters in certain regions, it is contemplated that in some examples, the capillary tube need not have regions of reduced diameter.

In sensor 200, conduit 205 comprises an optical fiber having a core 340. This core 340 may have a diameter 345. First capillary tube diameter 325 may be smaller than diameter 345 of core 340 of input optical conduit 205. This selection of the relative sizes of the core diameter of the input conduit and the capillary tube diameter at the optical junction between the input conduit and the capillary guides the input light from the core of the input conduit into the annular body of the capillary. This in turn guides the input light away from the core (i.e. capillary tube 310) of the capillary and guides more of the input light towards outer surface 305 of the capillary field generator 210. Guiding more of the input light towards and near outer surface 305 may enhance the generation of optical field 230 (shown in FIG. 2) extending outside outer surface 305 of the capillary field generator 210. In some examples, this enhancement of the optical field may include enhancement in characteristics of the optical field such as its strength, reach or extent, and the like. This enhancement of the optical field may allow for enhanced interactions with target 135 (shown in FIG. 2), which in turn may enhance the performance of the optical sensor.

In some examples, first capillary tube diameter 325 may be less than about 5 microns. Moreover, as shown in FIG. 3, first capillary tube diameter 325 may be smaller than second capillary tube diameter 330. In other words, the diameter of the capillary tube may be reduced at the optical junction of the capillary with the input conduit, relative to the diameter of the capillary tube away from the optical junction.

As mentioned above, the capillary also has a third capillary tube diameter 335 at second end 320. This capillary tube diameter 335 may be smaller than second capillary tube diameter 330. It is also contemplated that in some examples capillary tube diameter 335 may be about the same as capillary tube diameter 330. Moreover, output optical conduit 215 may comprise an optical fiber having a core 350, which core 350 may have a diameter 355. Capillary tube diameter 335 may be smaller than core diameter 355.

Although FIG. 3 shows a certain variations of the capillary tube diameter along the length of the capillary, and a certain relative diameters of optical fiber cores 340 and 350, it is contemplated that in some examples the capillary tube of capillary optical field generator and the fiber cores of the input and output conduits may have diameters different than those shown in FIG. 3. It is also contemplated that in some examples, a capillary optical field generator may be used with input and output optical conduits that are other than optical fibers. Furthermore, in some examples, the capillary field generator 210 may have an index of refraction that remains substantially unchanged when moving along the capillary from first end 315 to second end 320.

As shown in FIG. 2, optical field 230 extends out of outer surface 305 of the capillary field generator 210. In some examples, the capillary may be free of a covering on a portion of, or all of, the outer surface of the capillary. In some examples, such a covering may include a coating, cladding, and the like. Such a covering may interfere with optical field 230 extending out of the outer surface of the capillary, or reduce the extent or intensity of the optical field that would be available to interact with a target positioned outside the field generator. Ensuring that some or all of the outer surface of the capillary is free of such a covering may enhance the optical field that is able to extend out of the outer surface of the capillary and the field's interaction with a potential target for optical sensing.

Turning now to FIG. 4, a schematic representation is shown of another example optical sensor 400. Similar to optical sensors 100 and 200, optical sensor 400 comprises input optical conduit 205, an optical field generator 405, and output optical conduit 215. A difference between optical sensors 200 and 400 is that in sensor 400 field generator 405 comprises a coreless optical fiber. While some optical fibers comprise a core to conduct light and a cladding on an outside of the core to cover and protect the core, in some examples the coreless optical fiber may comprise the core but need not comprise a cladding.

The coreless optical fiber has a first end optically coupled to input optical conduit 205 and a second end opposite the first end. The send end is optically coupled to output optical conduit 215. The coreless optical fiber field generator 405 may be free of a covering on some or all of the outer surface of the coreless optical fiber. Field generator 405 may generate an optical field 410 extending out of the outer surface of the coreless optical fiber field generator 405. Optical field 410 may be similar to optical field 230. Optical field 410 may interact with target 135 to generate an altered light, which altered light may be guided by field generator 405 towards output optical conduit 215. Output conduit 215 may then guide the altered light to a detector 140.

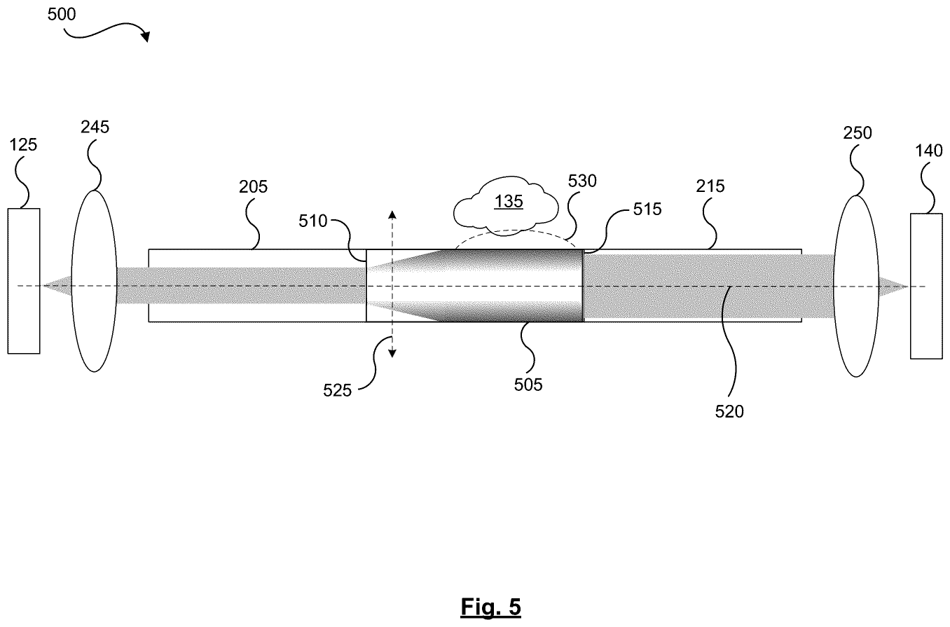

FIG. 5 shows a schematic representation of yet another example optical sensor 500. Similar to optical sensors 100, 200, and 400, optical sensor 500 comprises input optical conduit 205, an optical field generator 505, and output optical conduit 215. A difference between optical sensors 400 and 500 is that in sensor 500 field generator 505 comprises a light guide having a spatially variable index of refraction. Light guide optical field generator 505 has a first end 510 optically coupled to input optical conduit 205 and a second end 515 opposite the first end. Second end 515 is optically coupled to output optical conduit 215. The light guide has an axis of light propagation 520 extending through the light guide from first end 510 to second end 515. The light guide has an index of refraction that changes along the light guide along a direction 525 lateral to axis of light propagation 520. In examples where the light guide is cylindrical, lateral direction 525 would be the radial direction of the cylindrical light guide.

In some examples, the index of refraction of light guide field generator 505 may increase when moving along direction 525 from the core of the light guide towards the outer surface of the light guide. In other words, the index of refraction of the light guide may increase when moving (laterally to the axis of light propagation) from the core of the light guide outwardly towards the outer surface of the light guide.

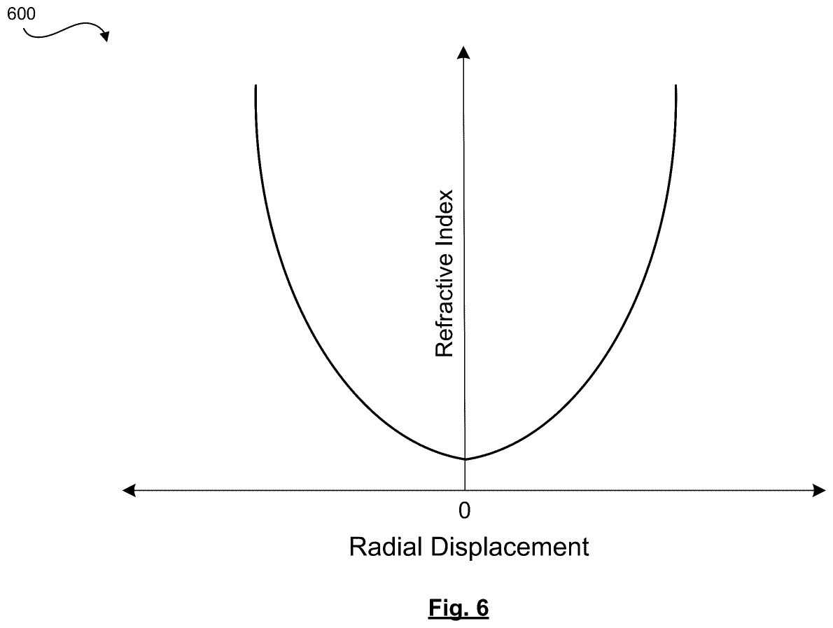

This spatially variable refractive index profile may guide more of the input light away from the core of light guide field generator 505 and towards the outer surface of field generator 505. An example spatially variable refractive index profile 600 is shown in FIG. 6. In refractive index profile 600, the refractive index increases with increased radial displacement from the core of the light guide towards the outer surface of the light guide. Note that in profile 600, both directions of the “radial displacement” axis represent increased displacement from the core of the light guide, which core is represented as zero displacement on the Radial Displacement axis in profile 600. It is also contemplated that in some examples, spatially variable refractive index profiles other than profile 600 may also be used.

Guiding more of the input light towards and near the outer surface of light guide field generator 505 may enhance the generation of optical field 530 extending outside the outer surface of field generator 505. In some examples, this enhancement of optical field 530 may include enhancement in characteristics of the optical field such as its strength, reach or extent, and the like. This enhancement of the optical field may allow for enhanced interactions with target 135, which in turn may enhance the performance of optical sensor 500.

In some examples, the spatially variable refractive index profile may be achieved using a photonic crystal. In other words, in some examples, light guide optical field generator 505 may comprise a photonic crystal. The refractive index of a photonic crystal may be tailored by adjusting properties of the photonic crystal such as its periodicity, lattice parameter, and the like. Moreover, in some examples, the photonic crystal may be in the form of a photonic crystal fiber.

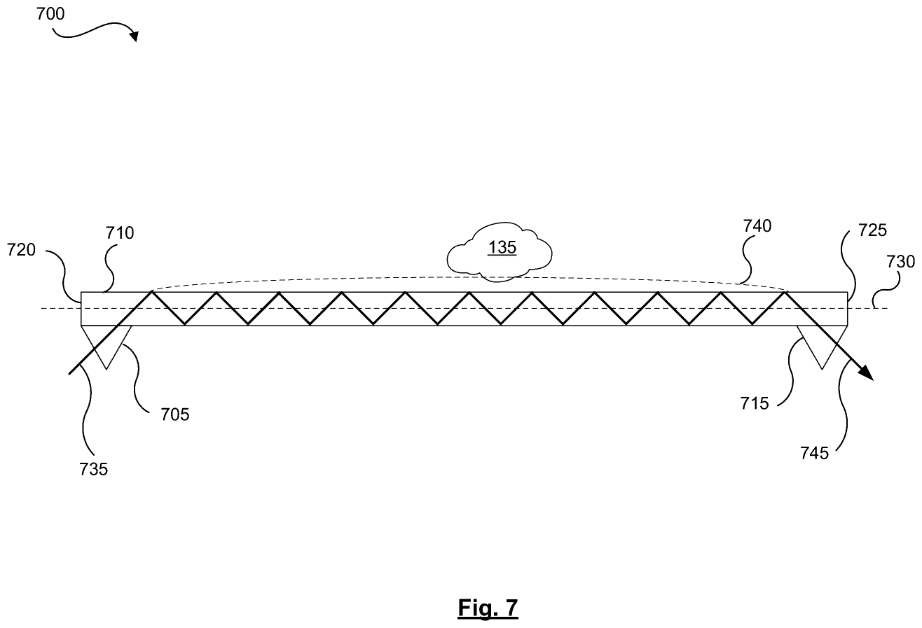

Turning now to FIG. 7, a schematic representation is shown of another example optical sensor 700. Sensor 700 comprises an input optical conduit 705, an optical field generator 710, and an output optical generator 715. Input and output optical conduits 705 and 715 each comprise a prism. It is contemplated that in some examples, one or more of the input and output optical conduits may comprise, instead or in addition to prisms, other optical elements such as gratings, metasurfaces, and the like. Optical field generator 710 comprises a light guide having a first end 720 and a second end 725 opposite first end 720. Field generator 710 is optically coupled to input optical conduit 705 proximate first end 720, and is coupled to output optical conduit 715 proximate second end 725.

Light guide field generator 710 has an axis of light propagation 730 extending through the light guide from first end 720 to second end 725. In some examples, light guide field generator 710 may have a polygonal cross-section normal to the axis of light propagation. Examples of such a polygonal cross-section may include a cross-section that is a rectangle, square, parallelogram, diamond, trapezoid, and the like.

Field generator 710 may receive an input light 735 from input optical conduit 705. Field generator 710 may then generate based on input light 735 an optical field 740 extending outside of the outer surface of field generator 710. Optical field 740 may then interact with target 135 to generate an altered light 745, which altered light is guided by field generator 710 towards output optical conduit 715.

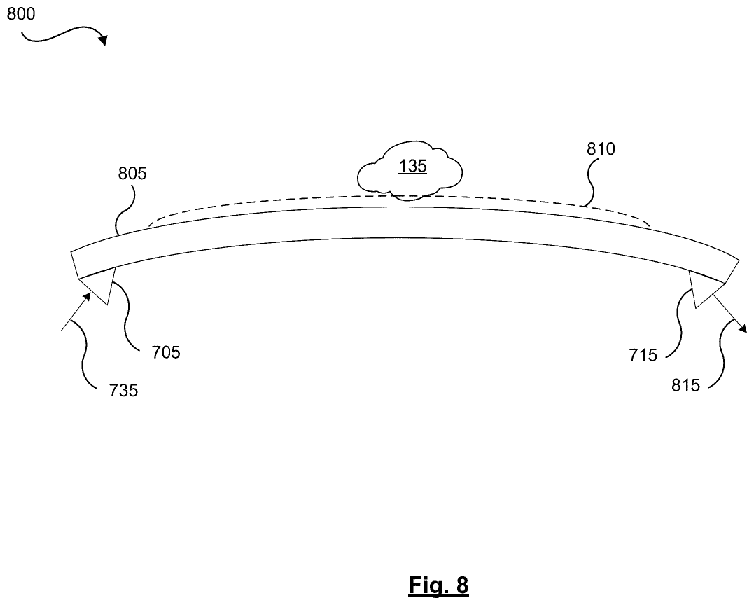

In some examples, the light guide field generator may be shaped such that the axis of light propagation is non-straight. FIG. 8 shows an example of an optical sensor having such a non-straight axis of light propagation. FIG. 8 shows a schematic representation of an example optical sensor 800. Sensor 800 may be similar to sensor 700, with a difference being that sensor 800 comprises an optical field generator 805 having a curved axis of light propagation. Field generator 805 may receive input light 735 via input optical conduit 705, and may generate an optical field 810 based on input light 735. Optical field 810 extends outside the outer surface of field generator 805, and may interact with target 135 to generate an altered light 815. Field generator 805 may guide altered light 815 towards output optical conduit 715. It is also contemplated that in some examples, the axis of light propagation may have a non-straight shape other that that shown in FIG. 8.

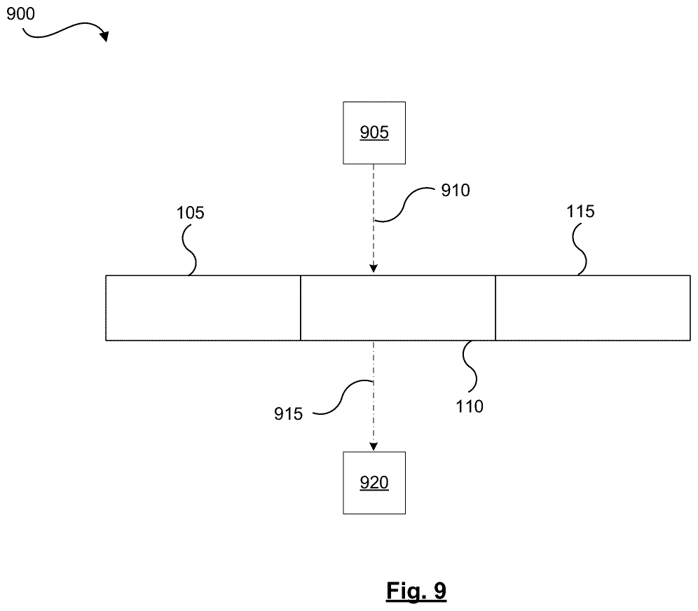

In addition, in some examples, the optical field generator may become damaged or dirty over time. For example, dirt or other substances may accumulate on the outer surface of the field generator. Moreover, the outer surface of the field generator may also become damaged due to physical or chemical agents; examples of such damage may include abrasion, etching, pitting, and the like. Such damage or dirt may degrade the optical field generated by the field generator or may otherwise undermine the performance of the optical sensor. FIG. 9 shows a schematic representation of another example optical sensor 900, which sensor has the ability of assess the condition of the field generator to assess for sensor performance degraders such as damage, dirt, and the like.

Sensor 900 comprises input and output optical conduits 105 and 115, and optical field generator 110. Sensor 900 also comprises an emitter 905 disposed outside of optical field generator 110. Emitter 905 may emit an incident optical beam 910 transverse to optical field generator 110. Incident optical beam 910 may become incident upon optical field generator 110 to generate an emitted optical beam 915 emanating from optical field generator 110. In some examples, incident beam 910 may comprise electromagnetic radiation that is capable of being at least partially transmitted through optical field generator 110 when field generator 110 is in its clean and undamaged state. Moreover, in some examples, incident beam 910 may comprise a light beam.

Sensor 900 also comprises a detector 920 to detect emitted optical beam 915. An insertion loss may be generated or calculated based on incident and emitted optical beams 910 and 915. Such an insertion loss may be associated with a condition of the field generator. For example, the insertion loss may be calculated as the ratio of the intensity of the emitted optical beam to the incident optical beam. For such an insertion loss, a value close to one may represent a relatively clean or undamaged field generator, whereas deviation from one may be correlated with dirt or damage affecting the field generator. It is contemplated that in some examples, other ways of calculating the insertion loss may also be used.

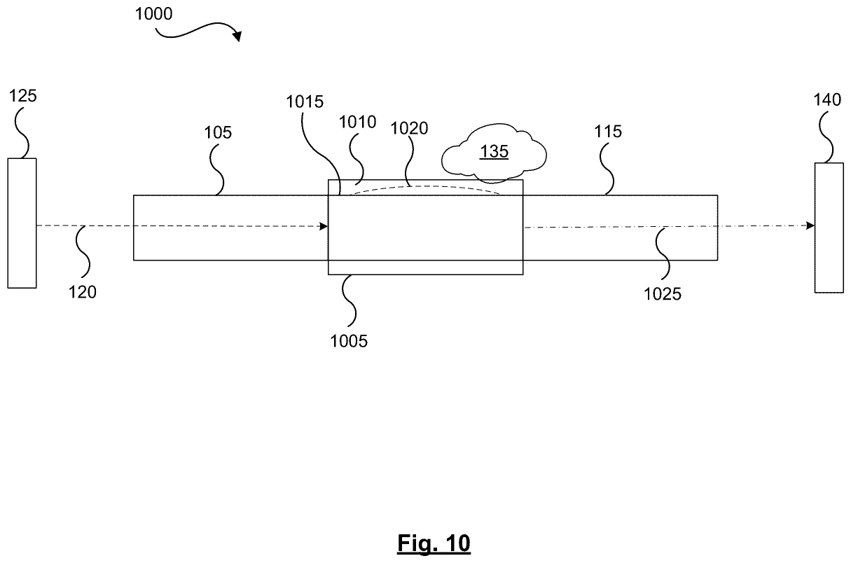

In some examples, the optical field generator may have a coating on at least a portion of its outside surface, which coating is sensitive to the target to be sensed by the optical sensor. Upon interacting with the target, an optical property of the coating may change. The optical field generated by the field generator may then interact with the coating, which interaction may be different depending on whether the coating has come into contact with the target. In this way the optical sensor may sense the target indirectly, namely by sensing a change in the coating caused by the target. FIG. 10 shows a schematic representation of an example optical sensor 1000 whose field generator has such a coating.

Sensor 1000 comprises input and output optical conduits 105 and 115. Sensor 1000 also comprises an optical field generator 1005. Field generator 1005 may be similar to field generator 110, with a difference being that field generator 1005 comprises a coating 1010 on the outside surface 1015 of field generator 1005 exposed to target 135. While FIG. 10 shows coating 1010 covering substantially all the outside surfaces of field generator 1005 (other that those surfaces connected to input and output optical conduits), it is contemplated that in some examples the coating may partially cover the outside surface of the field generator. In this description, outer surface and outside surface are used interchangeably, unless the context indicates otherwise.

Coating 1010 may have an optical property, and may interact with target 135 which interaction may alter that optical property. In other words, interaction with the target may form an altered coating having the altered optical property. Field generator 1005 may generate optical field 1020 which then interacts with the altered coating to generate an altered light 1025. Field generator 1005 may guide altered light 1025 towards output optical conduit 115, which conduit may then guide altered light 1025 towards a detector 140.

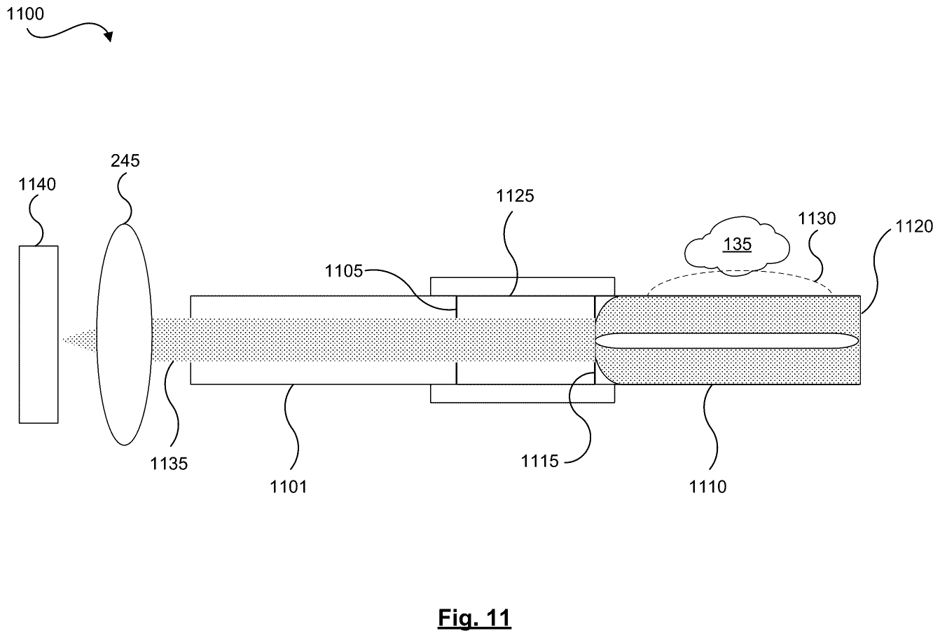

Turning now to FIG. 11, a schematic representation is shown of an example optical sensor 1100. Sensor 1100 comprises optical conduit 1101 terminating in a first end 1105. Sensor 1100 also comprises an optical field generator 1110, which has an end 1115 and another end 1120 opposite end 1115. In some examples, end 1120 may be at least partially reflective of the light propagating in field generator 1110. FIG. 11 shows field generator 1110 as comprising a capillary similar to field generator 210 shown in FIG. 2. It is also contemplated that in some examples, field generator 1110 need not comprise a capillary, and may comprise another one of the field generators described here, or a different suitable field generator.

Sensor 1100 comprises an optical resonance chamber formed between end 1105 and end 1115, and is at least partially isolated from the environment external to sensor 1100 to keep out at least target 135. Optical conduit 1101 may receive an input light and guide that light towards optical resonance chamber 1125. Optical field generator 1110 may receive the input light from optical resonance chamber 1125 and generate, based on the input light, an optical field 1130 extending at least partially outside optical field generator 1110. Optical field 1130 may interact with target 135 positioned outside optical field generator 1110. This interaction may generate an altered light. Field generator 1110 may guide this altered light to optical resonance chamber 1125.

In optical resonance chamber 1125 the altered light may interfere with the input light to generate an output light. Optical conduit 1101 may receive the output light from optical resonance chamber 1125. In some examples, optical resonance chamber 1125 may comprise a Fabry-Perot chamber.

In FIG. 11, beam 1135 represents both the input light and the output light, travelling in opposite directions. Component 1140 may comprise both a light source and a light detector. It is also contemplated that in some examples, the light source and detector may be separate components. In such examples, appropriate optics may be used to direct the input light from the light source to sensor 1100 and to direct the output light from sensor 1100 to the detector. Furthermore, in some examples, sensor 1100 may have separate input and output optical conduits.

It is contemplated that the field generator described in relation to any one of the optical sensors described herein may be used in, or incorporated into, one or more of the other optical sensors described herein. Moreover, it is contemplated that the features and functions described in relation to any one of the optical sensors described herein may be combined with, or incorporated into, one or more of the other optical sensors described herein.

Throughout this specification and the appended claims, infinitive verb forms are often used. Examples include, without limitation: “to receive,” “to generate,” “to guide,” and the like. Unless the specific context requires otherwise, such infinitive verb forms are used in an open, inclusive sense, that is as “to, at least, receive,” to, at least, generate,” “to, at least, guide,” and so on.

The above description of illustrated example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An optical sensor for sensing a target, the optical sensor comprising:
an input optical conduit, an output optical conduit, and an optical field generator optically coupled to the input optical conduit and the output optical conduit;
the input optical conduit to receive an input light and to guide the input light towards the optical field generator;
the optical field generator to:
receive the input light from the input optical conduit;
generate based on the input light an optical field extending at least partially outside of the optical field generator to interact with the target to generate an altered light, the target positioned outside the optical field generator; and
guide the altered light to the output optical conduit; and
the output optical conduit to receive the altered light from the optical field generator.

2. The optical sensor of claim 1, wherein the optical field generator comprises a capillary having an outer surface and a capillary tube, the capillary having a first end optically coupled to the input optical conduit and a second end opposite the first end, the second end optically coupled to the output optical conduit, the capillary to generate the optical field extending outside of the outer surface of the capillary.

3. The optical sensor of claim 2, wherein:
the input optical conduit comprises an optical fiber having a core, the core having a core diameter;
the capillary tube having a first capillary tube diameter at the first end and a second capillary tube diameter away from the first end and away from the second end; and
the first capillary tube diameter is smaller than the core diameter.

4. The optical sensor of claim 3, wherein the first capillary tube diameter is less than about 5 microns.

5. The optical sensor of claim 3, wherein the first capillary tube diameter is smaller than the second capillary tube diameter.

6. The optical sensor of claim 3, wherein the capillary tube has a third capillary tube diameter at the second end, the third capillary tube diameter being smaller than the second capillary tube diameter.

7. The optical sensor of claim 6, wherein:
the output optical conduit comprises a corresponding optical fiber having a corresponding core, the corresponding core having a corresponding core diameter; and
the third capillary tube diameter is smaller than the corresponding core diameter.

8. The optical sensor of claim 3, wherein the capillary is free of a covering on the outer surface of the capillary.

9. The optical sensor of claim 1, wherein the optical field generator comprises a coreless optical fiber having a first end optically coupled to the input optical conduit and a second end opposite the first end, the second end optically coupled to the output optical conduit, the coreless optical fiber being free of a covering on an outer surface of the coreless optical fiber.

10. The optical sensor of claim 1, wherein the optical field generator comprises a light guide having a first end optically coupled to the input optical conduit and a second end opposite the first end, the second end optically coupled to the output optical conduit, the light guide having an axis of light propagation extending through the light guide from the first end to the second end, the light guide having an index of refraction that changes along the light guide along a direction lateral to the axis of light propagation.

11. The optical sensor of claim 10, wherein the index of refraction increases when moving along the direction from a core of the light guide towards an outer surface of the light guide.

12. The optical sensor of claim 10, wherein the light guide comprises a photonic crystal fiber.

13. The optical sensor of claim 1, wherein the optical field generator comprises a light guide having a first end and a second end opposite the first end, the optical field generator optically coupled to the input optical conduit proximate the first end and optically coupled to the output optical conduit proximate the second end, the light guide having an axis of light propagation extending through the light guide from the first end to the second end, the light guide having a polygonal cross-section normal to the axis of light propagation.

14. The optical sensor of claim 13, wherein the polygonal cross-section is a tetragonal cross-section.

15. The optical sensor of claim 13, wherein the light guide is shaped such that the axis of light propagation is non-straight.

16. The optical sensor of claim 13, wherein one or both of the input optical conduit and the output optical conduit comprise a prism optically coupled to the light guide.

17. The optical sensor of claim 1, wherein the optical field comprises an evanescent field.

18. The optical sensor of claim 1, wherein the input optical conduit comprises an optical fiber.

19. The optical sensor of claim 1, wherein the output optical conduit comprises an optical fiber.

20. The optical sensor of claim 1, further comprising one or more of:
a light source to generate the input light, the light source optically coupled to the input optical conduit; and
a detector to detect the altered light, the detector optically coupled to the output optical conduit.

21. The optical sensor of claim 1, wherein the output optical conduit is to guide the altered light towards a detector.

22. The optical sensor of claim 1, wherein the output optical conduit is a component of a detector.

23. The optical sensor of claim 2, wherein the capillary has an index of refraction that remains substantially unchanged when moving along the capillary from the first end to the second end.

24. The optical sensor of claim 1, further comprising:
an emitter disposed outside the optical field generator, the emitter to emit an incident optical beam transverse to the optical field generator, the incident optical beam to become incident upon the optical field generator to generate an emitted optical beam emanating from the optical field generator;
a detector to detect the emitted optical beam; and
whereby an insertion loss is to be generated based on the incident optical beam and the emitted optical beam, the insertion loss being associated with a condition of the optical field generator.

25. The optical sensor of claim 1, further comprising a coating on at least a portion of a surface of the optical field generator exposed to the target, the coating having an optical property, the coating to interact with the target to form an altered coating having an altered optical property, wherein:
the optical field is to interact with the altered coating to generate the altered light.

26. An optical sensor for sensing a target, the optical sensor comprising:
an optical conduit terminating in a first end;
an optical field generator having a second end and a third end opposite the second end;
an optical resonance chamber formed between the first end and the second end, the optical resonance chamber being at least partially isolated from an environment external to the optical sensor to keep out at least the target;
the optical conduit to receive an input light and to guide the input light towards the optical resonance chamber;
the optical field generator to:
receive the input light from the optical resonance chamber;
generate based on the input light an optical field extending at least partially outside of the optical field generator to interact with the target to generate an altered light, the target positioned outside the optical field generator; and
guide the altered light to the optical resonance chamber; and
wherein:
the altered light is to interfere with the input light in the optical resonance chamber to generate an output light; and
the optical conduit is to receive the output light from the optical resonance chamber.

27. The optical sensor of claim 26, wherein the optical resonance chamber comprises a Fabry-Perot chamber.
